(19) United States
(12) Patent Application Publication
(10) Pub. No.: US 2025/0187098 A1
(43) Pub. Date: Jun. 12, 2025

(54) BATTERY ENGINE DRIVE STUD WELDING SYSTEM WITH MULTI-CHANNEL BATTERY CONFIGURATION

(71) Applicant: Nelson Stud Welding, Inc., Elyria, OH (US)

(72) Inventors: William S. Houston, Avon, OH (US); Douglas S. Phillips, Elyria, OH (US)

(21) Appl. No.: 18/977,208

(22) Filed: Dec. 11, 2024

Related U.S. Application Data
(60) Provisional application No. 63/614,076, filed on Dec. 22, 2023.
(60) Provisional application No. 63/608,446, filed on Dec. 11, 2023.

(51) Int. Cl. B23K 9/20

(52) U.S. Cl. CPC B23K 9/20

(57) ABSTRACT

A stud welder for a stud welding system includes a battery pack that includes a plurality of battery cells, an input module configured to receive charging current from an engine-generator and selectively provide the charging current to the battery cells of the battery pack, an output module configured to selectively output a welding current from the battery cells of the battery pack, and a controller configured to selectively supply the welding current to a stud weld gun of the stud welder.

### CROSS-REFERENCE TO RELATED APPLICATIONS

This application claims the benefit of U.S. Provisional Application No. 63/614,076, filed Dec. 22, 2023, and U.S. Provisional Application No. 63/608,446, filed Dec. 11, 2023. The entire disclosures of the above applications are incorporated by reference.

### FIELD

The present disclosure relates to stud welding systems, and more particularly to battery design for battery-powered, portable stud welding systems.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Stud welding is a technique for welding a fastener, such as stud or other fastener, to a base metal of a work piece. Various stud welding systems are known in the art for this purpose. One such type of stud welding system is an engine-generator stud welding system, which typically includes a stud welder and an engine-generator (e.g., a diesel-powered generator configured to output electrical power to power the stud welder).

Another such type of stud welding system is known as a capacitive discharge (CD) system, which typically includes a charging circuit, an energy storage device (e.g., one or more capacitors), and a discharge circuit that extends through a weld stud gun. Typically, the power supply for such welding systems is an external source of AC power. In operation, the energy storage device is discharged to create an arc between a stud that is connected to the weld stud gun and the work piece, thereby heating up the stud and the work piece. When the arc is complete, the weld stud gun plunges the stud into the heated area on the work piece to create a weldment.

### SUMMARY

A stud welder for a stud welding system includes a battery pack that includes a plurality of battery cells, an input module configured to receive charging current from an engine-generator and selectively provide the charging current to the battery cells of the battery pack, an output module configured to selectively output a welding current from the battery cells of the battery pack, and a controller configured to selectively supply the welding current to a stud weld gun of the stud welder.

In other features, the battery cells are Lithium Ion battery cells. The battery cells are Lithium Iron Phosphate (LiFePO4) battery cells. The battery pack is configured to supply the welding current at greater than or equal to 2000 amps at a predetermined duty cycle. The battery pack is configured to supply the welding current at 3000 amps. The battery pack includes a plurality of battery channels comprising the plurality of battery cells, each of the battery is configured to output a respective individual welding current, the input module is configured to selectively provide the charging current to the battery channels of the battery pack, the output module is configured to selectively supply the individual welding currents as a total welding current, and the controller is configured to selectively supply the total welding current to the stud weld gun of the stud welder.

In other features, the battery pack includes four of the battery channels, each of the plurality of battery channels is configured to supply the respective individual welding current at greater than or equal to 500 amps, the input module includes a plurality of first switches corresponding to the plurality of battery channels, and the plurality of first switches is responsive to at least one of the controller and respective battery management systems of the plurality of battery channels, the output module includes a plurality of second switches corresponding to the plurality battery channels, and the plurality of second switches is responsive to at least one of the controller and the respective battery management systems of the plurality of battery channels. In some examples, a stud welding system includes the stud welder.

A method of operating a stud welder for a stud welding system includes generating and outputting a charging current using an engine-generator, receiving, at a battery pack that includes a plurality of battery cells, the charging current output by the engine-generator, generating and selectively outputting a welding current from the plurality of battery cells, and selectively supplying the welding current to a stud weld gun of the stud welder. The battery cells are Lithium Ion battery cells. The battery cells are Lithium Iron Phosphate (LiFePO4) battery cells. The method further includes supplying the welding current at greater than or equal to 2000 amps at a predetermined duty cycle. The method further includes supplying the welding current at 3000 amps.

In other features, the battery pack includes a plurality of battery channels comprising the plurality of battery cells. Each of the plurality of battery channels selectively receives the charging current output by the engine-generator. Generating the welding current includes generating a plurality of respective individual welding currents using the plurality of battery channels. Selectively outputting the welding current includes outputting one or more of the plurality of respective individual welding currents as a total welding current. The battery pack includes four of the battery channels. Each of the plurality of battery channels is configured to supply the respective individual welding current at greater than or equal to 500 amps.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

FIG. 1A shows an example engine-generator battery stud welding system including a battery module configured according to the principles of the present disclosure;

FIG. 1B is a functional block diagram of the example engine-generator battery stud welding system of FIG. 1A;

FIG. 2 is a functional block diagram of an example portable stud welding system including a battery module or pack configured in accordance with the principles of the present disclosure;

FIG. 3A is a functional block diagram of an example battery pack, input module, and output module according to the principles of the present disclosure;

FIG. 3B a functional block diagram of an example controller according to the principles of the present disclosure;

FIG. 4 illustrates steps of an example method of operating a stud welding system according to the principles of the present disclosure; ad

FIGS. 5A, 5B, and 5C show views of an example stud welder and battery pack having a multi-channel battery configuration according to the principles of the present disclosure;

FIG. 6A shows an example battery module according to the principles of the present disclosure; and

FIG. 6B illustrates steps of an example method of assembling a battery module according to the principles of the present disclosure.

In the drawings, reference numbers may be reused to identify similar and/or identical elements.

### DETAILED DESCRIPTION

Engine-generator stud welding systems typically include an engine-generator configured to output electrical power to power a stud welder. The engine-generator (which is typically diesel-powered), while mobile, is large and difficult to maneuver. Accordingly, the stud welder may be remotely located from the engine-generator and receives power from the engine-generator via one or more cables or cords. Further, engine-generators are typically extremely loud (e.g., greater than 80 dB) and are not fuel efficient.

An engine-generator stud welding system according to the present disclosure (which may be referred to as a battery engine drive stud welding system) includes one or more batteries, battery modules, battery packs, etc. (e.g., engine-generator battery stud welding systems). The engine-generator is configured to selectively supply power directly to the stud welder, charge/recharge the battery, or combinations thereof. Further, the battery may be configured to supply power to the stud welder to power welding functions. Accordingly, the battery may be used to power the stud welder when the stud welder is disconnected from or otherwise not receiving power from the engine-generator. In this manner, engine-generator battery stud welding systems are configured to perform welding tasks in areas that may be difficult to reach for a stud welder connected to an engine-generator. Further, the availability of the battery to power welding functions significantly reduces the size of the engine-generator (e.g., by five times or more), which reduces engine noise (e.g., to less than 76 dB) and improves fuel efficiency (e.g., by 50% or more). In some examples, the engine-generator includes a gasoline internal combustion engine (i.e., instead of a diesel engine).

In an example, the engine-generator stud welding system of the present disclosure includes an engine-generator or engine drive module (which includes an engine and charging generator), a stud welder or welding module (which includes various circuitry and power electronics configured to receive power, convert power, control a welder etc.), and a battery module or assembly. As described herein, the stud welder according to the present disclosure has a reduced weight (e.g., less than 1500 pounds) relative to conventional engine-generator stud welding systems while providing a stud welding capacity of over 2400 amps.

In some examples, the battery module includes a multi-channel battery configuration (e.g., four or more battery cells connected in parallel and/or in series). Each individual channel is independently controllable. The individual battery channels allow dynamic configurations of battery channels used for weld output in parallel or series depending on the demands of the welding process and respective battery channels can be used for both output and charging simultaneously. For example, each battery channel is coupled between respective input and output switches that are controlled to selectively couple each battery channel to charging power, an output to the stud welder, etc. In this manner, individual battery channels may be combined to achieve a battery configuration sufficient to supply an output current of any given welding application. Conversely, one or more individual battery channels may be supplied with charging current while other battery channels are used to supply welding output (i.e., welding current). As used herein in some examples, “battery module” may refer to a battery pack comprising a plurality of battery modules.

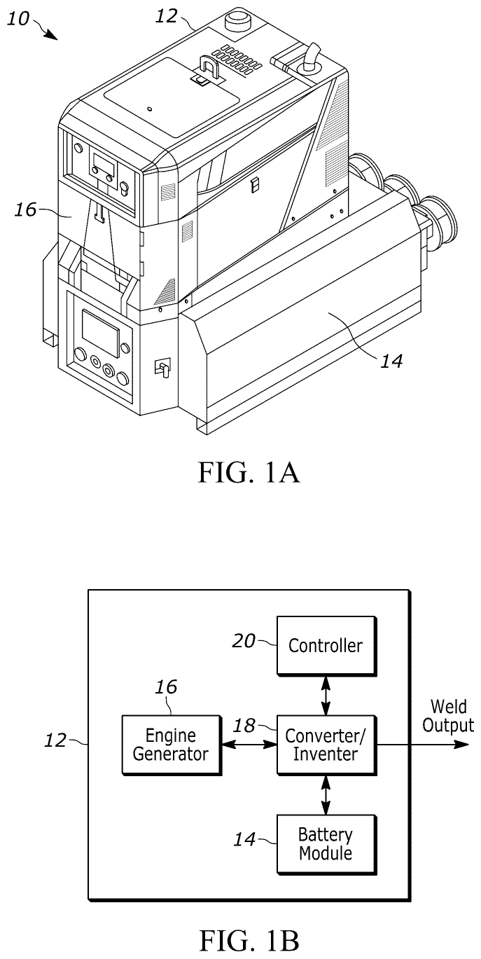

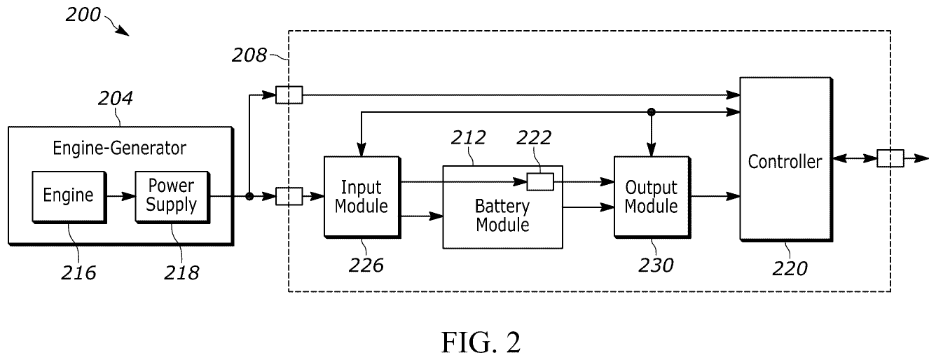

FIGS. 1A and 1B show an example engine-generator battery stud welding system 10 configured according to the principles of the present disclosure, including a stud welder 12, a battery, battery pack, or battery module 14, and an engine-generator 16. The battery module 14 may be arranged within the stud welder 12 (as shown) or external to the stud welder 12. The battery module 14 may include one or more rechargeable batteries, such as a rechargeable Lithium Ion (Li-Ion) battery. One example type of Li-Ion battery is a Lithium Iron Phosphate (LiFePO4) battery. A LiFePO4 battery module includes a plurality of LiFePO4 battery cells. In some examples, the battery cells are connected in parallel. In other examples, the battery cells are connected in series. In still other examples, the battery cells may be connected in various combinations of parallel and series connections.

The engine-generator may 16 be configured to selectively supply power directly to the stud welder 12 and/or to the battery module 14 (e.g., to charge the battery module 14). For example, the engine-generator 16 includes a 25 horsepower engine configured to provide power to a charging generator, which in turn provides charging power to the battery module 14. As shown, the engine-generator 16 is internal to/integrated within the stud welder 12 (e.g., within a housing enclosing components of the stud welder 12 as well as the engine-generator 16). In other examples, the engine-generator 16 may be external to the stud welder 12. Accordingly, the stud welder 12 according to the principles of the present disclosure may be configured to operate with various types of engine-generators.

The battery module 14 is configured to supply power to the stud welder 12 to power welding functions. Accordingly, the battery module 14 may be used to power the stud welder 12 when the stud welder 12 is disconnected from or otherwise not receiving power from the engine-generator 16. In some examples, the stud welder 12 includes a converter/inverter 18 (e.g., an AC to DC converter, a DC to AC converter, a transformer, etc.) or other circuitry configured to convert electrical power supplied from the engine generator 16 to electrical power suitable for charging the battery module 14, electrical power suitable for welding functions, etc. The converter/inverter 18 is further configured to convert electrical power from the battery module 14 to electrical power suitable for welding functions. Accordingly, the stud welder 12 is configured to provide welding functions using power supplied from the engine-generator 16 and/or power supplied from the battery module 14 (e.g., when the stud welder 12 is not connected to or otherwise receiving power from the engine-generator 16).

The stud welder 12 may include a controller 20. The controller 20 is configured to control various operational, diagnostic, and safety functions of the stud welder 12, such as controlling operation of the converter/inverter 18 (e.g., controlling whether welding functions are powered using the battery module 14 or the engine-generator 16, controlling charging of the battery module 14 etc.), controlling welding output, sensing input and output values and controlling various operations of the components of the stud welding system 10 based on the sensed input and output values, etc.

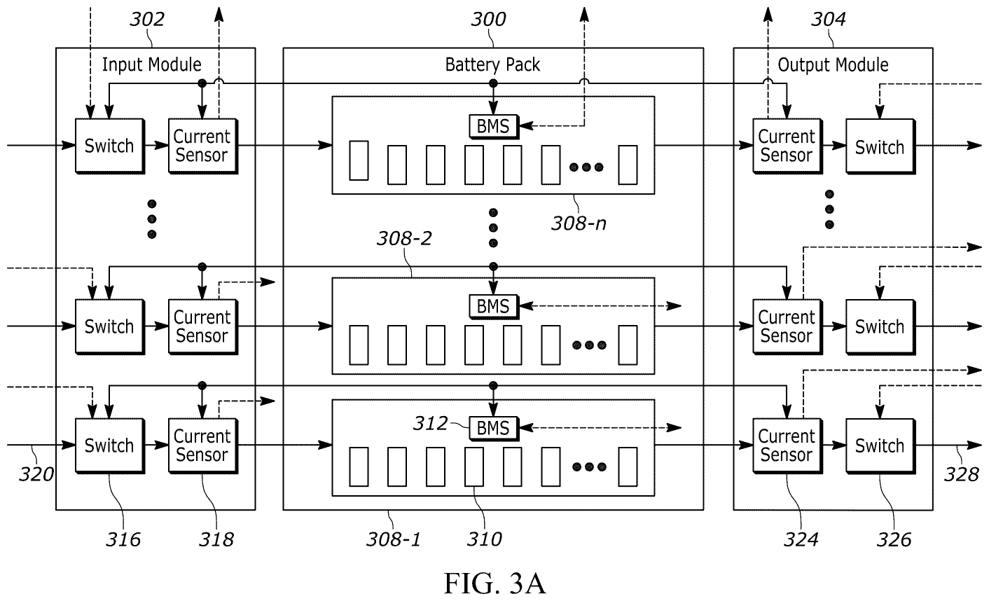

FIG. 2 is a functional block diagram of an example engine-generator battery stud welding system 200 including an engine-generator 204, a stud welder 208, and a battery module 212 each configured in accordance with the principles of the present disclosure. For example, the stud welding system 200 may correspond to the stud welding system 10 described above with respect to FIGS. 1A and 1B. Although shown separate from the stud welder 208, the engine-generator 204 may be enclosed within a same housing as the stud welder 208 as described above, enclosed in a different housing attached to the stud welder 208, etc. Accordingly, in some examples, the system 200 may correspond to a portable system or unit comprising both the engine-generator 204 and the stud welder 208 as shown in FIG. 1A.

The engine-generator includes an engine 216 (e.g., an internal combustion engine) and a power supply (e.g., a charging generator) 218. The engine 216 generates mechanical energy, which the engine-generator 204 converts to electrical energy input to the power supply 218. The power supply 218 converts the electrical energy to charging/welding current (e.g., a DC current) output to the stud welder 208. As shown, the power supply 218 may, via respective input terminals, supply charging current to the battery module 212 and/or supply welding current to controller 220. The controller 220 is configured to selectively provide welding power to a welding output terminal as received from the battery module 212 and/or as received from the power supply 218.

In some examples, the battery module 212 includes one or more battery management systems (BMSs) 222 configured to implement various fault protection techniques, such as short circuit protection, prevention of overcharging of cells, and selective disablement of discharging of the battery module 212 (e.g., disabling discharging upon reaching a low threshold output voltage to prevent cell damage, upon reaching a high temperature limit, etc.). For example, for a battery module 212 having a multi-channel configuration as described herein in more detail, each battery channel may include a respective BMS 222). In some examples, the stud welder 208 may include additional components (e.g., a boost converter, one or more energy storage devices, such as capacitors, etc.) omitted from FIG. 2 for simplicity.

The controller 220 is configured to execute various operational, diagnostic, and safety functions, such as providing instructions (e.g., control signals) to a weld gun (e.g., a stud weld gun) to control welding output, controlling output of power to the stud weld gun, sensing input and output values (e.g., corresponding to voltage and/or current sensed at various input and output terminals, controlling various operations of the components of the stud welding system 200 based on the sensed input and output values, etc. As one example, the controller 220 is configured to discontinue welding using power from the battery module 212 when the battery module 212 reaches a low charge level. In some examples, the controller 220 provides a notification (e.g., provides a visual and/or audible warning) in response to a charge of the battery module 212 being below a threshold.

The controller 220 of the present disclosure is further configured to selectively and independently control charging power supplied to, and welding power provided from, each of the battery channels of the battery module 212. In other words, the controller 220 is configured to selectively turn on and off charging power supplied to the battery channels of the battery module 212 from the power supply 218, selectively turn on and off welding power supplied from the battery channels of the battery module 212 to the stud weld gun (e.g., via the controller 220), control the ratio of welding power supplied to the stud weld gun from the power supply 218 and the battery module 212, etc.

As one example, the battery module 212 is coupled between an input module 226 and an output module 230. The input module 226 and the output module 230, as described below in more detail, each include respective circuitry configured to selectively supply and limit charging power provided from the power supply 218 to the individual battery channels of the battery module 212, control welding power provided from the individual battery channels of the battery module 212 to the stud welder, etc. The circuitry may include, but is not limited to, input and output switches and input and output current sensing circuitry coupled to respective ends of the individual battery channels.

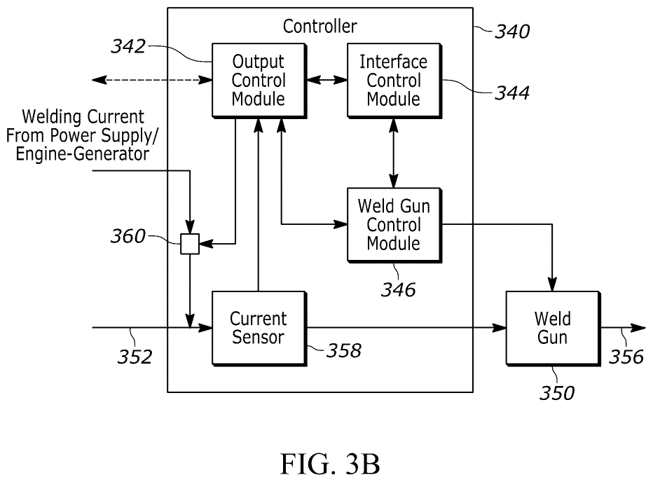

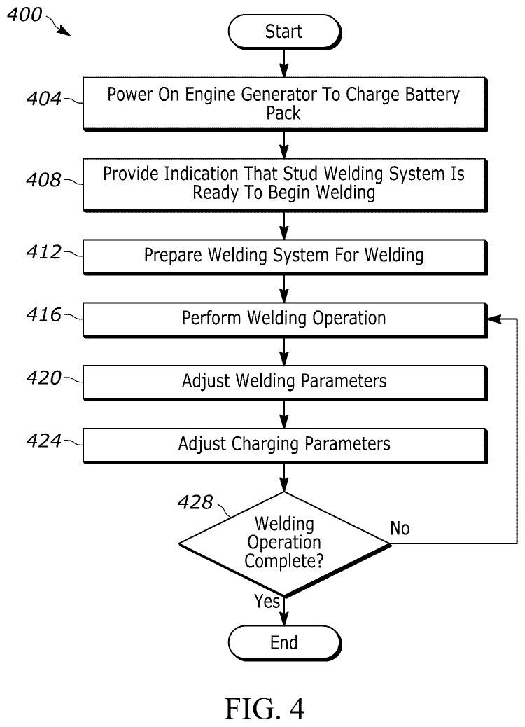

FIG. 3A shows an example battery pack 300 (e.g., corresponding to a plurality of the battery modules 212 described above) having a multi-channel configuration according to the present disclosure. The battery pack 300 is shown coupled between an input module 302 and an output module 304 each including respective circuitry configured to selectively supply and limit charging power provided to the battery pack 300 and control welding power provided from battery pack 300 to the stud welder.

The battery pack 300 includes a plurality of individual and separately controllable battery channels 308-1, 308-2, . . . , and 308-n, referred to collectively as battery channels 308. In an example, n equals four. Each of the battery channels (which may be referred to as batteries, battery modules, etc.) 308 includes a plurality of battery modules 310 (each including a respective plurality of battery cells) and a respective BMS 312. For example, each of the battery modules 310 includes a plurality of battery cells coupled in parallel and the battery modules 310 of a respective one of the battery channels 308 are coupled in series. In one example, each of the battery modules 310 includes 18 battery cells coupled in parallel, each of the battery channels 308 includes 24 of the battery modules 310 coupled in series, and the battery pack 300 includes 4 of the battery channels 308.

Each of the battery channels 308 may configured to supply, individually, up to 2160 amps of current and the battery pack 300 is configured to supply up to 8,640 amps of current (i.e., when all of the battery channels 308 are supplying a maximum welding current). In an example, a stud welding system comprising the battery pack 300 is configured (i.e., by design) to provide a minimum of 300 amps of welding current and a maximum of 3000 amps of welding current. In this example, each of the battery channels 308 may supply, individually, up to 750 amps of welding current and the battery pack 300 may supply up to 3000 amps of welding current when each of the battery channels 308 is supplying 750 amps. Each of the battery channels 308 may supply same or different amounts of current to achieve a desired welding current. For example, to output the minimum 300 amps of welding current, only one of the battery channels 308 can be controlled to supply 300 amps, two of the battery channels 308 can be controlled to each supply 150 amps, four of the battery channels 308 can be controlled to each supply 75 amps of welding current, etc.

The input module 302 includes a plurality of pairs of switches 316 and current sensors 318 corresponding to respective battery channels 308. In an example, the switches 316 include charging relays (e.g., high power relays). In other examples, other types of switching circuitry may be used. Each of the switches 316 is controlled (e.g., by a respective BMS 312) to selectively supply charging current 320 (e.g., a DC charging current received from a power supply as described above) to a respective battery channel 308. For example, each BMS 312 is configured to implement various fault protection techniques, such as short circuit protection, prevention of overcharging of battery cells, over-temperature protection, disablement of discharging/supply of charging current from the battery pack 300, etc. In some examples, the switches 316 are controlled in response to measurements of the charging currents as sensed and provided by the current sensors 318.

Similarly, the output module 304 includes a plurality of pairs of current sensors 324 and switches 326 corresponding to respective battery channels 308. In an example, the switches 326 include switching transistors, such as insulate-gate bipolar transistors (IGBTs). In other examples, other types of power transistors or switching circuitry may be used. Each of the switches 316 is controlled to selectively supply welding current 328 from a respective battery channel 308. In some examples, the switches 326 are controlled in response to measurements of the welding currents as sensed and provided by the current sensors 324.

Although described with respect to control via the BMS 312, components of the battery pack 300, the input module 302, and the output module 304 are further responsive and provide measurement signals to a controller 340 (e.g., corresponding to the controller 220 of FIG. 2) as shown in more detail in FIG. 3B. For example, as shown by dashed lines in FIGS. 3A and 3B, the BMS 312 and the switches 316 and 326 are responsive to control signals received from the controller 340. In some examples, the welding current 328 is supplied to the controller 340, which in turn controls the welding current supplied to (and other operational functions of) the stud weld gun. Conversely, the BMS 312 and the current sensors 318 and 324 provide signals (e.g., measurement signals, diagnostic signals, etc.) to the controller 340.

As shown in FIG. 3B (with continued reference to FIG. 3A), the controller 340 includes an output control module 342, an interface control module 344, and a stud weld gun control module 346. The output control module 344 sends control signals to (and is responsive to signals received from) the battery pack 300, the input module 302, and the output module 304 as described above. For example, the output control module 342 is configured to control the switches 316 to selectively supply and stop supply of charging current to the individual battery channels 308 and to control the switches 326 to selectively supply and stop supply of welding current from the individual battery channels to a stud weld gun 350. For example, a welding current 352 supplied to the stud weld gun 350 as shown in FIG. 3B is a total welding current corresponding to a sum of all of the individual welding currents supplied from respective battery channels 308.

The output control module 342 is configured to control the switches 326 to supply a welding current 352 required to power a welding output 356 of the stud weld gun 350. For example, the interface control module 344 may receive a weld request signals (e.g., from an operator via one or more inputs of the interface control module 344, from a welding program, from the stud weld gun control module 346, etc.). The interface control module 344 may include and/or be configured to interface with various input and output devices, such as a buttons, switches, etc. configured to receive operator inputs, a display screen, etc. In some examples, the output control module 342 receives weld request signals such as signals indicating an amount of weld power required by the stud weld gun 350, weld on/off signals, etc.

The output control module 342 is configured to, based on the weld request signals, supply control signals to the stud weld gun control module 346 to selectively turn the stud weld gun 350 on and off and control the switches 326 based on the amount of weld power required by the stud weld gun 350. For example, the output control module 342 receives one or more indicators of the welding current 352 supplied to the stud weld gun 350, such as a measurement of welding current 352 as sensed and provided by a current sensor 358. The output control module 342 is configured to control the switches 326 to selectively supply and stop supply of current from individual battery channels 308 such that the welding current 352 is sufficient to meet the weld power required by the stud weld gun 350. In some examples, the output control module 342 is configured to control a duty cycle (i.e., a duty cycle less than 100%) of the welding current 352 supplied to the stud weld gun 350 (e.g., by controlling the switches 326 or other switches/switching circuitry).

In some situations, the controller 340 (e.g., the output control module 342) is configured to provide welding current directly from the power supply/engine-generator (i.e., instead of or in addition to the welding current 352 supplied by the battery channels 308). For example, the welding current may be supplied directly from the power supply in response to a determination that the battery pack 300 is below a minimum charge threshold, in response to detection of one or more faults (e.g., a short circuit, an over-temperature condition, etc.), in response to an input from the operator, etc. For example, the output control module 342 may be configured to control a switch or relay 360 to selectively supply and stop supply of the welding current as received directly from the power supply. Although shown within the controller 340, the switch 360 may be located external to the controller 340, such as in the input module 302 or the output module 304.

In this manner, the controller 340 and/or the BMSs 312 are configured to operate the switches 316 and 326 to selectively charge and discharge individual battery channels 308. In some examples, the BMSs 312 are configured to control the switches 316 to selectively charge the battery channels 308 (e.g., based on minimum charge thresholds) while the controller 340 is configured to control the switches 326 to supply a desired welding current 352. In other words, the BMSs 312 may be configured to control charging of the battery channels 308 to maintain minimum charge requirements of the battery channels 308 (i.e., to perform charge balancing functions) while the controller 340 is configured to control discharging of the battery channels 308 to maintain the desired welding current 352. In other examples, both the BMSs 312 and the controller 340 are configured to control the switches 316 and the switches 326.

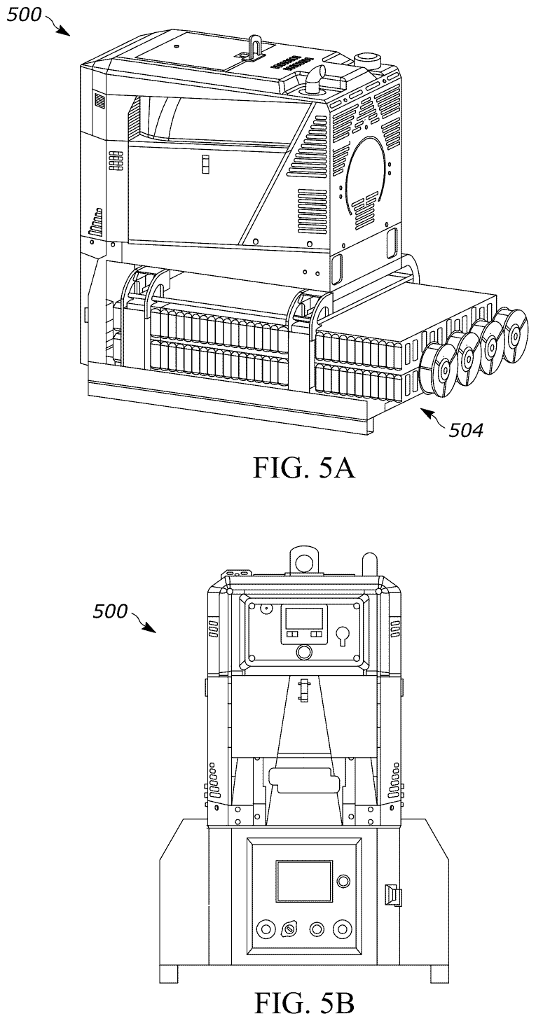

FIG. 4 illustrates steps of an example method 400 of operating a stud welding system according to the principles of the present disclosure. For example, one or more systems and respective processing devices, controllers, etc. described herein may be configured to perform the method 400, such as the system 10, the system 200, etc.

At 404, an engine generator is started/powered on to supply charging current to a battery pack of a stud welder of the stud welding system. At 408, the method 400 generates and provides an indication that the stud welding system is ready to begin welding (e.g., an indication that the battery pack has reached a minimum charge threshold, such as a minimum voltage of the battery pack, required for welding). For example, the interface control module 344 may output a charge indication to a display, activate an LED or other indicator, etc. Optionally, charging for one or more of the battery channels may be stopped (e.g., by controlling the switches 316, turning off the engine generator, etc.

At 412, the stud welding system is prepared for welding. For example, an operator of the stud welding system may connect a stud weld gun and/or other cables (e.g., power cables, a grounding cable, etc.) to the stud welder in response to the indication that the battery pack has reached the minimum charge threshold and charging can begin. In some examples, a weld schedule/program and/or other operating parameters are input to the stud welding system. For example, a weld schedule is programmed into the controller 340 via the interface control module 344. Preparing the stud welding system may also include, but is not limited to, loading/positioning one or more studs, ferrules, and/or other materials for welding.

At 416, the method 400 begins to perform a welding operation. For example, welding current is supplied to a stud weld gun in accordance with a required welding output indicated by the weld schedule. In an example, in response to a request to begin welding (e.g., received from the interface control module 344, the stud weld gun control module 346, etc.), the output control module 342 controls one or more of the switches 326 to supply the welding current 352. For example, the output control module 342 closes one, two, or more of the switches 326 based on the required welding output, which may be dependent upon characteristics of the studs being welding. As one example, the required welding output is calculated (or stored, such as in a lookup table stored in memory implemented by the controller 340) based on a thickness of the stud indicated by the weld schedule, as input via the interface control module 344, etc.).

At 420, the method 400 (e.g., the controller 340, the BMSs 312, etc.) optionally adjusts welding parameters. For example, the controller 340 may control the switches 326 to increase or decrease the welding current 352 (e.g., based on the weld schedule or other inputs/measurements), adjust a duty cycle of the welding current 352, etc. In some examples, one or more of the switches 326 may be closed while one or more others of the switches 326 are opened (e.g., to maintain a same welding current 352 but from a different configuration of the battery channels 308). For example, the controller 340 (responsive to the BMSs 312 and/or other measurement signals) may control the switches 326 to provide the required welding current 352 while ensuring that none of the battery channels 308 decreases below a minimum charge threshold, respective temperatures of the battery channels 308 do not exceed a temperature threshold, respective currents supplied by the battery channels 308 do not exceed a current threshold, etc. In still other examples, the controller 340 may receive welding current directly from the engine-generator instead of and/or in addition to the battery channels 308.

At 424, the method 400 (e.g., the BMSs 312, the controller 340, etc.) optionally adjusts charging parameters to charge the battery pack during welding. For example, the method 400 determines whether a charge level (e.g. a voltage) of the battery pack is less than a threshold and selectively re-initiates charging of one or more of the battery channels (e.g., by turning on the engine-generator and/or controlling the switches 316) in response to the charge level being less than the threshold. In other words, the method 400 may be configured to operate the stud welding system to supply welding output to perform welding while charging the battery pack in response to charge levels of one or more of the battery channels 308 decreasing. Charging may be initiated in response to charge levels of any one of the battery channels 308 decreasing below a respective individual channel threshold, an overall charge level of the battery pack decreasing below an overall battery pack threshold, etc.

At 428, the method 400 determines whether a current weld operation is complete (e.g., in accordance with the programmed weld schedule, in response to a command input from the operator, etc.). If true, the method 400 ends (e.g., by powering down one or more components of the stud welding system). If false, the method 400 continues to 416 and the welding operation continues.

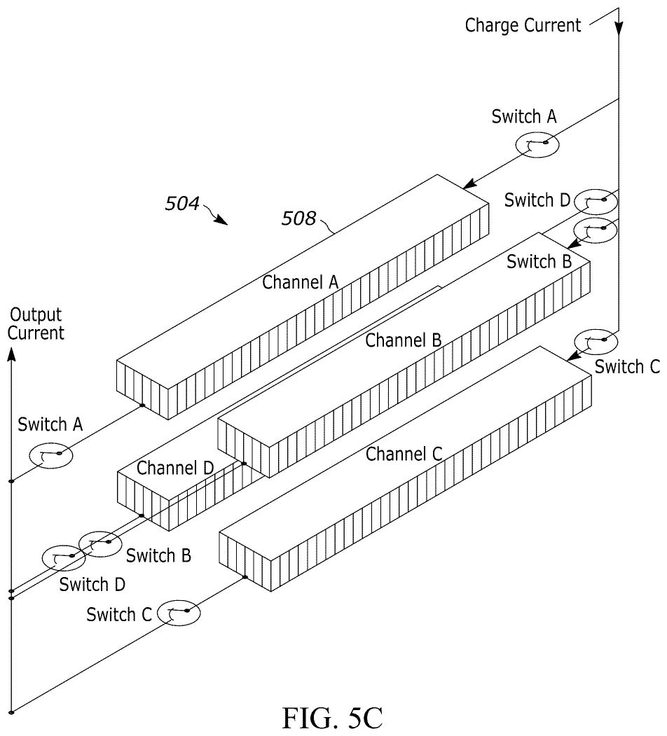

FIGS. 5A and 5B show side isometric and front views, respectively, of an example stud welder 500 including a battery pack 504 having a multi-channel battery configuration in accordance with the principles of the present disclosure. FIG. 5C is an exploded view of the battery pack 504 illustrating each of four battery channels 508. In this example, each of the battery channels 508 includes 24 battery modules and each of the battery modules includes 18 cells. Each of the battery channels 508 can be selectively and separately coupled to and disconnected from a charging current and a load (e.g., a stud weld gun) as described above.

Further, the battery pack 504 is configured such that each of the battery channels 508 may be separately removed and installed (i.e., from the battery pack 504 and the stud welder 500). Accordingly, if only one of the battery modules 508 requires servicing or replacement, the removing or replacing the entire battery pack 504 is not necessary.

In some examples, a welding system according to the present disclosure may use one or more rechargeable batteries, such as a battery module including a plurality of LiFePO4 battery cells. In an example, battery cells of an LiFePO4 battery connected in parallel are arranged between conductive (e.g., copper) bus plates. The bus plates include top and bottom bus plates, which may correspond, respectively, to positive and negative bus plates or negative and positive bus plates. For example, a positive bus plate is electrically coupled to positive terminals of the battery cells and a negative bus plate is electrically coupled to negative terminals of the battery cells. Typically, the bus plates are electrically coupled to respective terminals of the battery cells using thin conductive (e.g., copper) wires or ribbons extending between the bus plates and the terminals. The wires/ribbons are attached to the bus plates and the terminals of the batteries using various welding techniques (e.g., laser welding, ultrasonic friction welding, etc.). The wires/ribbons are susceptible to damage, especially in high vibration environments such as welding systems. Accordingly, the welds and electrical connections between the bus plates and the terminals may be broken or otherwise damaged.

In another example, a plurality of thin intermediate conductive (e.g., nickel) plates are coupled together in a laminate plate and arranged between the bus plate and the terminals of the battery cells. However, assembling a laminate plate in this manner is costly and time-consuming.

In some embodiments, a battery module or assembly (and a method of assembly thereof) according to the principles of the present disclosure includes composite bus plate assemblies coupled to the terminals of the battery cells. Each of the bus plate assemblies includes a thin intermediate plate (i.e., a single plate) coupled to the bus plate and to the terminals of the battery cells. The intermediate plate is coupled to the bus plate and to the terminals using traditional welding techniques, such as resistance welding or laser welding. In an example, the intermediate plate is welded to the bus plate and then welded to the terminals through openings arranged in the bus plate using spot welding techniques. The battery module of the present disclosure is configured to withstand high vibration while supplying higher current (e.g., relative to batteries having bus plates coupled to the terminals using conductive wire or ribbons as described above) and therefore provides increased performance and durability.

In some examples, the bus plate is comprised of copper or copper alloy, nickel-plated copper, etc. In other examples, one or more other materials may be used, such as aluminum or aluminum alloys. Similarly, the intermediate plate may be comprised of nickel or nickel alloys, nickel-plated copper, or other materials. In an example, the intermediate plate is comprised of a same material and has a same thickness as the terminals of the battery cells.

The thickness of the bus plate is selected in accordance with maximum current to be delivered from the battery module to a load (e.g., a welding load) through the bus plate. For example, for a welding system configured to provide a welding current of 3000 amps using a N different battery modules, each battery module may supply 3000/N amps through respective bus plates. Accordingly, for a battery pack including four battery modules, up to 750 amps of current may flow through each bus plate.

Further, for a given thickness, different materials allow different current flow rates and heat transfer (i.e., for cooling) capabilities. Since heat transfer and cooling capability increases as thickness of the bus plate increases, the material and thickness (as well as length, cross-sectional area, etc.) of the bus plate is selected to achieve required current flow while also maximizing thickness for heat transfer and cooling. As cross-sectional area increases, an internal resistance of the bus plate decreases and causes a decrease in the rate at which temperature of the bus plate increases for a given current and duty cycle. Conversely, as thicknesses increases, cost and weight increase and the resistance welding capability decreases (requiring higher current to perform welding). Further, as welding current increases, the thin intermediate plate is more likely to melt. Accordingly, the material and thickness of the bus plate according to the principles of the present disclosure are selected in accordance with a plurality of factors, including but not limited to, a maximum current to be supplied by the battery module and a thickness and material of the intermediate plate. In one example, the bus plate is comprised of copper and has a thickness of approximately (e.g., within 10% of) 0.125 inches.

Conversely, the material and thickness of the intermediate plate (which may be implemented as a thin layer, foil, etc.) are selected based on a thickness of the battery terminals of the battery cells (e.g., a plating on the battery terminals). For example, the intermediate plate according to the present disclosure has the same thickness and material as the terminals of the battery cells. In an example, the battery terminals include nickel plating and the intermediate plate is comprised of nickel, a nickel alloy, etc. having a same thickness as the nickel plating on the battery terminals (e.g., 0.010 to 0.025 inches thick).

The thickness of the intermediate plate is selected based on the amount of current supplied to the bus plate from the battery cells. For example, the intermediate plate is configured to flow respective currents from each of the cells. In one example, for a battery module comprising 18 cells (e.g., connected in parallel) supplying a total of 750 amps of current through the bus plate, the intermediate plate is required to supply 750/18=41.7 amps.

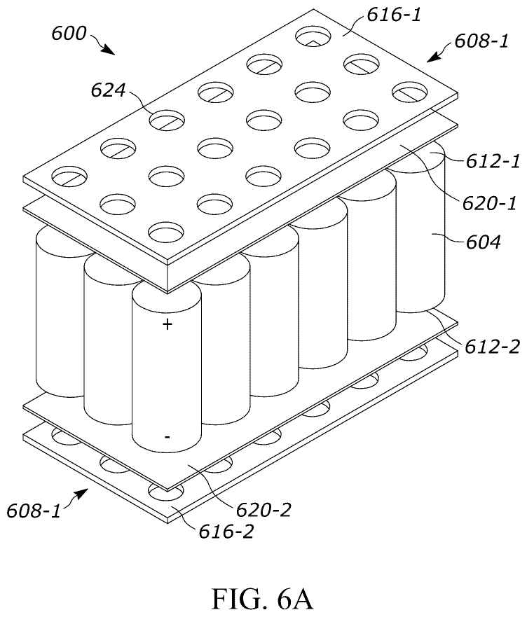

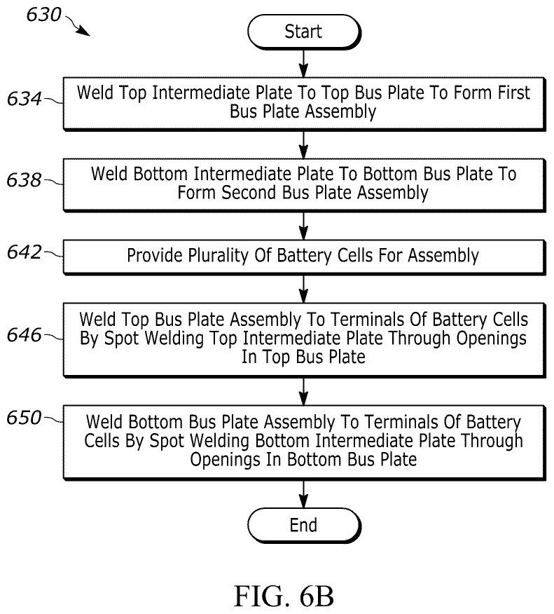

FIG. 6A shows an example battery module 600 according to the principles of the present disclosure. While described with respect to the stud welding system 200, the battery pack 300, etc., the battery module 600 may be implemented in other types of systems. In an example, the battery module 600 is a Lithium Iron Phosphate (LiFePO4) battery including a plurality of LiFePO4 battery cells 604. As shown, the battery cells 604 are connected in parallel between composite bus plate assemblies 608-1 and 608-2 (e.g., top and bottom bus plate assemblies 608-1 and 608-2, referred to collectively as bus plate assemblies 608). In other examples, the battery cells 604 may be arranged in various combinations of parallel and series connections. In an example, the battery module 600 has an air-cooled configuration. For example, the battery module 600 is configured to facilitate flow of air between and around the battery cells 604.

In this example, the top and bottom bus plate assemblies 608-1 and 608-2 correspond to positive and negative bus plate assemblies, respectively. According, the top bus plate assembly 608-1 is electrically coupled to positive terminals 612-1 of the battery cells 604 and the bottom bus plate assembly 608-2 is electrically coupled to negative terminals 612-2 of the battery cells 604 (referred to collectively as terminals 612).

The bus plate assemblies 608 according to the present disclosure include respective conductive bus plates 616 (collectively referring to top bus plate 616-1 and bottom bus plate 616-2) and respective conductive intermediate plates 620 (collectively referring to top intermediate plate 620-1 and bottom intermediate plate 620-2). In an example, each of the bus plate assemblies 608 includes a single one of the bus plates 616 and a single one of the intermediate plates 620. In this manner, welding and assembly of the battery module 604 are simplified. The intermediate plates 620 may be thinner than the bus plates 616. For example, the intermediate plates 620 have a thickness 50% or less than a thickness of the bus plates 616. In an example, the bus plates 616 are comprised of copper or a copper alloy. Conversely, the intermediate plates 620 comprise a different material than the bus plates 616. In an example, the intermediate plates 620 comprise nickel or a nickel alloy. Similarly, the terminals 612 may be nickel-plated.

As shown, the intermediate plates 620 are approximately the same size and shape as the bus plates 616. For example, lengths and widths the intermediate plates 620 are within 10% of lengths and widths of the bus plates 616, and both the intermediate plates 620 and the bus plates 616 are generally planer and rectangular. In other examples, the intermediate plates 620 and the bus plates 616 may have same or different sizes and/or shapes (e.g., generally square, trapezoidal, etc., depending on a size and/or shape required to facilitate integration within the stud welding system 200).

Accordingly, the intermediate plates 620 are comprised of a same material as the terminals 612. In this manner, problems associated with an interface between the bus plate assemblies 608 and the terminals 612 comprising different materials are minimized or eliminated. For example, problems such as galvanic corrosion between the terminals 612 and the bus plate assemblies 608 may occur when different materials are used. Conversely, in this example, galvanic corrosion is avoided since the intermediate plates 620 and the terminals 612 each are comprised of nickel (or other same material).

The intermediate plates 620 are electrically coupled to the bus plates 616. For example, the intermediate plates 620 are welded (resistance welded, laser welded, etc.) together. In other examples, other techniques may be used to electrically couple the intermediate plates 620 to the bus plates 616 (e.g., brazing). Further, the intermediate plates 620 are directly coupled to the bus plates 616. In other words, each of the intermediate plates 620-1 and 620-2 is directly coupled to the bus plates 616-1 and 616-2, respectively, and no additional plate is arranged between the intermediate plates 620 and the bus plates 616.

In an example, the intermediate plates 620 are spot-weldable. For example, the intermediate plates 620 are comprised of a material (e.g., nickel, as described above) having a significantly greater resistance than (e.g., four times, five times, etc.) a resistance of the bus plates 616. Accordingly, the intermediate plates 620 may be spot-welded to the bus plates 616.

Similarly, the intermediate plates 620 are directly, electrically coupled to the terminals 612 within no additional plate arranged between the intermediate plates 620 and the terminals 612. For example, the intermediate plates 620 are spot-welded to the terminals 612. As shown, the bus plates 616 include a plurality of access holes or openings 624. The openings 624 are aligned with respective terminals 612 of the battery cells 604. Accordingly, the bus plate assemblies 608 may be electrically coupled to the battery cells 604 by spot welding the intermediate plates 620 to the terminals 612 through the respective openings 624. In an example, diameters of the openings 624 are selected to facilitate spot-welding. For example, the diameters of the openings 624 are selected to facilitate achieving a desired weld size. The diameters of the openings 624 may be 40%-60% of diameters of the battery cells 604.

As described, the bus plate assemblies 608 of the present disclosure can be securely and rigidly coupled to the battery cells 604. More specifically, the intermediate plates 620 are directly coupled (e.g. using spot welding or other welding techniques) to the bus plates 616 and the terminals 612. Accordingly, the battery module 600 of is configured to withstand high vibration while supplying higher current (e.g., relative to batteries having bus plates coupled to the terminals using conductive wire or ribbons) and therefore provides increase performance and durability. Further, because the bus plate assemblies 608 are each comprised of only one of the bus plates 616 and one of the intermediate plates 620 (i.e., instead of multiple bus plates or intermediate plates, such as a plurality of intermediate plates in a laminate plate assembly), assembly is simplified and likelihood of delamination is reduced.

FIG. 6B illustrates steps of an example method 630 of assembling a battery module (e.g., the battery module 600) according to the principles of the present disclosure. At 634, a first (e.g., top) intermediate plate is welded to a first (e.g., top) bus plate to form a first (e.g., top) bus plate assembly. For example, a nickel top intermediate plate is spot welded to a copper top bus plate having a plurality of openings. The openings may be formed in the top bus plate via stamping or other machining techniques.

At 638, a second (e.g., bottom) intermediate plate is welded to a second (e.g., bottom) bus plate having a plurality of openings to form a second (e.g., bottom) bus plate assembly. For example, a nickel bottom intermediate plate is spot welded to a copper bottom bus plate.

At 642, a plurality of battery cells (e.g., LiFePO4 batter cells) are provided for assembly. For example, the battery cells are arranged in a configuration to facilitate alignment between terminals of the battery cells and the openings in the top and bottom bus plates. In an example, the terminals are comprised of (e.g., plated with) a same material as the top and bottom intermediate plates. For example, the terminals of the battery cells are nickel-plated.

At 646, the top bus plate assembly is welded to terminals (e.g., positive terminals) of the battery cells. For example, the top bus plate assembly is arranged on the battery cells such that (i) the top intermediate plate is between the top bus plate and the terminals and adjacent to and in contact with the terminals and (ii) the plurality of openings in the top bus plate are aligned (e.g., concentric with) the terminals. The top intermediate plate is then spot-welded to the terminals through the openings.

At 650, the bottom bus plate assembly is welded to terminals (e.g., negative terminals) of the battery cells. For example, the bottom bus plate assembly is arranged on the battery cells such that (i) the bottom intermediate plate is between the bottom bus plate and the terminals and adjacent to and in contact with the terminals and (ii) the plurality of openings in the bottom bus plate are aligned (e.g., concentric with) the terminals. The bottom intermediate plate is then spot-welded to the terminals through the openings.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

“A”, “an”, and “the” as used herein refers to both singular and plural referents unless the context clearly dictates otherwise. By way of example, “a processor” or “processing device” configured and/or programmed to perform various functions may refer to one processor/processing device programmed to perform each and every function, more than one processor/processing device collectively programmed to perform each of the various functions, or more than one processor/processing device each individually programmed to perform each of the various functions.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A stud welder for a stud welding system, the stud welder comprising:
a battery pack that includes a plurality of battery cells;
an input module configured to receive charging current from an engine-generator and selectively provide the charging current to the battery cells of the battery pack;
an output module configured to selectively output a welding current from the battery cells of the battery pack; and
a controller configured to selectively supply the welding current to a weld stud gun of the stud welder.

2. The stud welder of claim 1, wherein the battery cells are Lithium Ion battery cells.

3. The stud welder of claim 2, wherein the battery cells are Lithium Iron Phosphate (LiFePO4) battery cells.

4. The stud welder of claim 1, wherein the battery pack is configured to supply the welding current at greater than or equal to 2000 amps at a predetermined duty cycle.

5. The stud welder of claim 4, wherein the battery pack is configured to supply the welding current at 3000 amps.

6. The stud welder of claim 1, wherein:
the battery pack includes a plurality of battery channels comprising the plurality of battery cells, wherein each of the battery channels is configured to output a respective individual welding current;
the input module is configured to selectively provide the charging current to the battery channels of the battery pack;
the output module is configured to selectively supply the individual welding currents as a total welding current; and
the controller is configured to selectively supply the total welding current to the stud weld gun of the stud welder.

7. The stud welder of claim 6, wherein the battery pack includes four of the battery channels.

8. The stud welder of claim 6, wherein each of the plurality of battery channels is configured to supply the respective individual welding current at greater than or equal to 500 amps.

9. The stud welder of claim 6, wherein the input module includes a plurality of first switches corresponding to the plurality of battery channels, and wherein the plurality of first switches is responsive to at least one of (i) the controller and (ii) respective battery management systems of the plurality of battery channels.

10. The stud welder of claim 9, wherein the output module includes a plurality of second switches corresponding to the plurality battery channels, and wherein the plurality of second switches is responsive to at least one of (i) the controller and (ii) the respective battery management systems of the plurality of battery channels.

11. A stud welding system comprising the stud welder of claim 1.

12. A method of operating a stud welder for a stud welding system, the method comprising:
generating and outputting a charging current using an engine-generator;
receiving, at a battery pack that includes a plurality of battery cells, the charging current output by the engine-generator;
generating and selectively outputting a welding current from the plurality of battery cells; and
selectively supplying the welding current to a stud weld gun of the stud welder.

13. The method of claim 12, wherein the battery cells are Lithium Ion battery cells.

14. The method of claim 13, wherein the battery cells are Lithium Iron Phosphate (LiFePO4) battery cells.

15. The method of claim 12, further comprising supplying the welding current at greater than or equal to 2000 amps at a predetermined duty cycle.

16. The method of claim 15, further comprising supplying the welding current at 3000 amps.

17. The method of claim 12, wherein:
the battery pack includes a plurality of battery channels comprising the plurality of battery cells, wherein each of the plurality of battery channels selectively receives the charging current output by the engine-generator;
generating the welding current includes generating a plurality of respective individual welding currents using the plurality of battery channels; and
selectively outputting the welding current includes outputting one or more of the plurality of respective individual welding currents as a total welding current.

18. The method of claim 17, wherein the battery pack includes four of the battery channels.

19. The method of claim 17, wherein each of the plurality of battery channels is configured to supply the respective individual welding current at greater than or equal to 500 amps.

20. The method of claim 17, further comprising providing a plurality of first switches corresponding to the plurality of battery channels, wherein the plurality of first switches is responsive to at least one of (i) a controller and (ii) respective battery management systems of the plurality of battery channels.
